(19) United States
(12) Patent Application Publication
(10) Pub. No.: US 2009/0236523 A1
(43) Pub. Date: Sep. 24, 2009

(54) Analysis apparatus and analysis method for semiconductor device

(75) Inventor: Toyokazu Nakamura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/382,677

(22) Filed: Mar. 20, 2009

(30) Foreign Application Priority Data
Mar. 21, 2008 (JP) 74194/2008

(51) Int. Cl. G01N 23/00

(52) U.S. Cl. 250/311; 250/310

(57) ABSTRACT

An analysis apparatus for a semiconductor device, capable of attaining highly efficient analysis of failure in the semiconductor device by a secondary-electron image, including: a region determination unit which determines a region constituting a secondary-electron image of a semiconductor device to be analyzed obtained by irradiating charged particle beam, based on the secondary-electron image and design data of the semiconductor device as a source of comparison; a material identification unit which identifies a material of each configuration of an image obtained by the region determination unit, based on the design data of the semiconductor device; a unit which calculates a potential in the each region identified by the material identification unit, based on the design data of the semiconductor device; a unit which colors each region of an image obtained by the material identification unit in accordance with the potential and generates a dummy good-product secondary-electron image; and a unit which displays the dummy good-product secondary-electron image and the secondary-electron image for the semiconductor device to be analyzed.

### BACKGROUND OF THE INVENTION

1. Field of the Invention

The present invention relates to an analysis apparatus and an analysis method for a semiconductor device and, in particular, to an analysis apparatus and an analysis method for a semiconductor device which perform analysis by observing a secondary-electron image obtained from a Scanning Electron Microscope, hereinafter referred to as a “SEM” and a Focused Ion Beam (FIB) apparatus.

2. Description of the Related Art

It has been known that SEM or FIB can be used to detect a malfunction which is difficult to find from a surface of a semiconductor device and an electrical malfunction by observing an secondary-electron image obtained from brightness conversion of the intensity of a secondary electron detected upon irradiation of a primary electron beam to a semiconductor device to be analyzed from an electron gun. For example, Japanese Patent Laid-Open No. 5-258703 has proposed die-die inspection of comparing images derived from a die and die database inspection of comparing an image derived from a die with an image generated by an image simulator (dummy good-product image) in which CAD data of the die is input.

Japanese Patent Laid-Open No. 7-306165 has disclosed an X-ray inspection apparatus capable of displaying a synthesized image obtained by synthesizing a graphic illustrating a shape of a subject prepared from design data and a transmission image or a Lamino image.

In addition, Japanese Patent Laid-Open No. 2003-86689 has disclosed a CAD tool capable of estimating a wiring having a doubtful fault or a defective position by collecting information of abnormal reaction obtained by physically analyzing a semiconductor device, extracting a duplicated position and checking against layout data.

FIG. 3 is a view illustrating an outline of die database inspection disclosed in Japanese Patent Laid-Open No. 5-258703. As illustrated in FIG. 3, with an advance of miniaturization of a semiconductor device, in a secondary-electron image observed with, usually, SEM or the like, an edge of an image pattern becomes round due to an effect of resolution thereof (refer to 100 at the lower left of FIG. 3). The SEM image 100 illustrates a pattern of a line and space of a wafer surface. (A) and (C) illustrate an insulation film which is a space and (B) illustrates a wiring which is a line. A portion (D) looking thick in the center of a portion (B) illustrates a defect such as “chipping” formed on a wiring surface. On the other hand, a dummy good-product image 101 to be compared has a drawback of difficult comparison due to the absence of roundness of an edge (refer to (a), (b) and (c) right down of FIG. 3) because the image is prepared from design data itself with high fidelity. In addition, such a comparison becomes made more difficult because the scale of a secondary-electron image is different from that of the dummy good-product image or the color of a potential distribution represented in the dummy good-product image is different from the concentration on the secondary-electron image.

Japanese Patent Laid-Open No. 7-306165 has disclosed that a graphic illustrating a shape of a subject prepared from design data is magnification-converted by an image processing unit, but even if a method described in Japanese Patent Laid-Open No. 7-306165 is applied, the drawbacks such as edge mismatch and concentration difference still remain.

It is an object of the present invention to detect a defect or a malfunction of an object to be analyzed with high efficiency without causing difficulty of comparison with the dummy good-product image described above.

### SUMMARY

According to a first aspect of the present invention, there is provided an analysis apparatus for a semiconductor device, including: a unit which inputs a secondary-electron image obtained by irradiating the semiconductor device with charged particle beam; design data of the semiconductor device as a source of comparison; a unit which categorizes a secondary-electron image of a semiconductor device as a source of comparison into regions for each potential, based on the secondary-electron image of the semiconductor device as the source of comparison; a unit which calculates a potential in the each region categorized for each potential of the secondary-electron image of the semiconductor device as the source of comparison, based on the design data of the semiconductor device as the source of comparison; a unit which colors the each region of the secondary-electron image of the semiconductor device as the source of comparison in accordance with the potential and generates a dummy good-product secondary-electron image; and a unit which displays the dummy good-product secondary-electron image and a secondary-electron image of a semiconductor device to be analyzed.

According to a second aspect of the present invention, there is provided an analysis method for a semiconductor device, including: determining a region constituting a secondary-electron image of a semiconductor device to be analyzed obtained by irradiating charged particle beam, based on the secondary-electron image and design data of the semiconductor device as a source of comparison; determining a material of each configuration of an image obtained by the region determination unit, based on the design data of the semiconductor device; calculating a potential in the each region identified by the material identification unit, based on the design data of the semiconductor device; coloring each region of an image obtained by the material identification unit in accordance with the potential and generating a dummy good-product secondary-electron image; and displaying the dummy good-product secondary-electron image and the secondary-electron image for the semiconductor device to be analyzed.

The present invention provides highly efficient detection of a malfunction potentially existing in a semiconductor device to be analyzed. This is the reason why a dummy good-product image to be compared is not prepared using design data, but comparison has been made possible with a dummy good-product secondary-electron image which has been colored to the same degree as a good product based on a potential concentration distribution calculated from design data using, as a basis, secondary-electron image of a semiconductor device as a source of comparison which is expectable to have the approximately same shape as an object to be compared.

### BRIEF DESCRIPTION OF THE DRAWINGS

The detailed description of the preferred embodiments for implementing the present invention will be made with reference to the drawings, in which:

FIG. 1 is a block diagram illustrating a configuration of an analysis apparatus for a semiconductor device according to the first embodiment of the present invention;

FIG. 2 is a block diagram illustrating a configuration of an analysis apparatus for a semiconductor device according to a second embodiment of the present invention; and

FIG. 3 is a view illustrating an outline of die database inspection disclosed in Japanese Patent Laid-Open No. 5-258703.

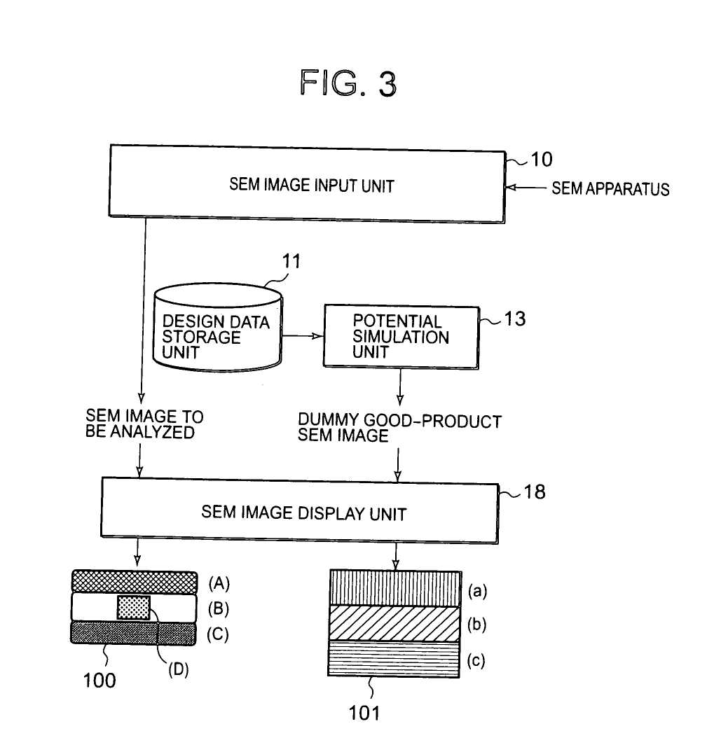

### DETAILED DESCRIPTION OF THE PREFERRED EMBODIMENTS

### First Embodiment

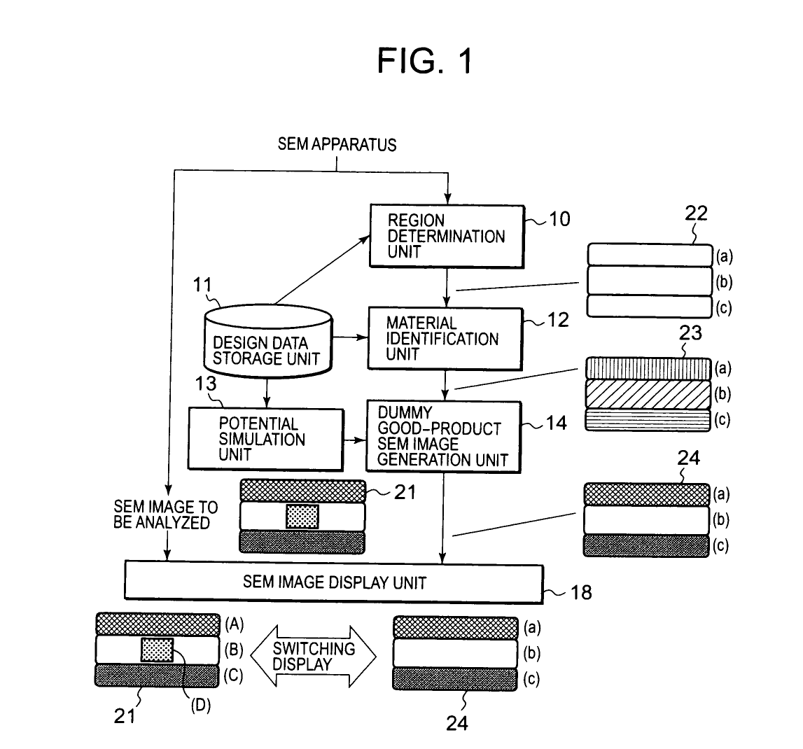

FIG. 1 is a block diagram illustrating a configuration of an analysis apparatus for a semiconductor device according to the first embodiment of the present invention.

Referring to FIG. 1, there is illustrated an analysis apparatus for a semiconductor device including a region determination unit 10, a design data storage unit 11, a material identification unit 12, a potential simulation unit 13, a dummy good-product SEM image generation unit 14 and a SEM image display unit 18.

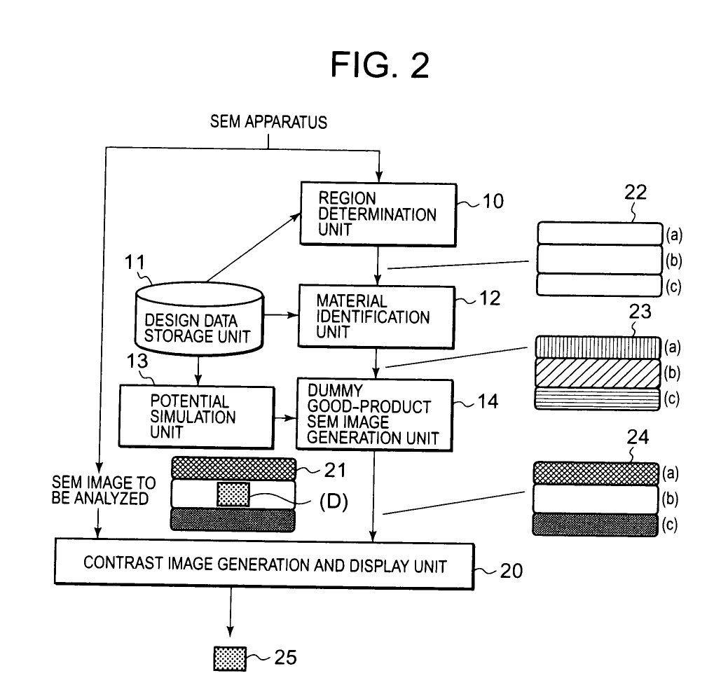

A semiconductor device, for example, a semiconductor wafer formed with a plurality of elements is introduced into the SEM apparatus and an observation position is set to an optional coordinate position of each element. Secondary-electron images (SEM images) of a semiconductor device to be analyzed is input into the analysis apparatus for a semiconductor device from the SEM apparatus, one of which is output to the region determination unit 10 and the other is output to a SEM image display unit 18 as a SEM image to be analyzed. Reference numeral 21 in FIG. 1 is an example of the SEM image to be analyzed. The SEM image illustrates a pattern of a line and space of a wafer surface and portions (A) and (C) illustrate an insulation film which is a space, respectively and a portion (B) illustrates a wiring which is a line. In addition, a portion (D) looking white in the center of the portion (B) illustrates a defect such as “chipping” formed on a wiring surface. In examples in FIGS. 1 and 2, a thick region (a) illustrates a high potential region (a plus potential region having low secondary electron energy) and a thin region (b) illustrates a low potential region (a minus potential region having high secondary electron energy).

The design data storage unit 11 stores design data (CAD data, layout data) such as wiring information, of a semiconductor device which is a source of comparison. An image 22 is an image obtained by the region determination unit 10. The image is an image obtained by extracting an edge portion of each configuration from a SEM image 21 to be analyzed because the roundness of an edge portion (outer frame) in each region constituting the SEM image 21 and a scale of the whole image are reflected into a similar good-quality image. The reason why no “chipping” appears in an image 22 is that, during image production, the design data in the same region as that of an object to be analyzed is referred to. The design data stores no defect information and therefore no reflection is made into the image 22. The SEM image to be analyzed used for extraction of the image 22 may use a SEM image of any of other elements on the same coordinate.

The material identification unit 12 identifies the material of the image 22 obtained by the region determination unit, referring to wiring information of design data (CAD data) stored in the design data storage unit 11. For example, potentials of a wiring connected to a p+ diffusion layer, a wiring connected to n+ diffusion layer, a wiring connected to poli-Si and a wiring connected to isolated poli-Si are calculated (simulated) from the design data (CAD data) and each region is identified as a region for each material. An image 23 is an example in which each region is identified for each material.

The potential simulation unit 13 calculates (simulates) a potential concentration distribution in each region identified by the material identification unit 12, using design data (CAD data) stored in the design data storage unit 11.

The dummy good-product SEM image generation unit 14 color-codes each region in which material has been identified, with the potential concentration calculated using the potential simulation unit 13, to generate a dummy good-product secondary-electron image. This is implemented by identifying and coloring the concentration relative to a potential calculated by the potential simulation unit 13, for example, using a relationship between a previously stored potential and concentration of secondary-electron image. An image 24 is an image after coloring, which becomes a dummy good-product SEM image 24.

The SEM image display unit 18 displays a secondary-electron image (SEM image) of a semiconductor device to be analyzed or as a source of comparison or the above-described dummy good-product secondary-electron image (SEM image) on a predetermined display apparatus. For example, depending on the user's operation, it is preferable to include a function of displaying, side by side, semiconductor device secondary-electron images (SEM images) to be analyzed and as a source of comparison for easy comparison, a function of alternately switching for displaying or a function of displaying by making one side translucent and overlapping over the other for displaying. Images on optional coordinates of a plurality of elements formed on a semiconductor wafer are sequentially observed and the SEM image 21 to be analyzed and the dummy good-product SEM image 24 are compared with each other, thus attaining more precise failure analysis than the conventional one.

The analysis apparatus for a semiconductor device constructed in this way can provide the dummy good-product secondary-electron image 24 (refer to (a) to (c) right down in FIG. 1) having the approximately same image pattern as the secondary electron image 21 (refer to (A) to (C) left down in FIG. 1) for a semiconductor device to be analyzed. As is evident from alternately looking at the electron images 21 and 24, an observer can facilitate identification of a defective position (D) of the semiconductor device to be analyzed.

Further, the analysis apparatus for a semiconductor device described above, configured for actual potential concentration of a secondary-electron image (SEM image) of a semiconductor device as a source of comparison to have no adverse effect upon concentration of an isopotential region of a dummy good-product secondary-electron image, can provide a dummy good-product secondary-electron image easy to compare with the semiconductor device to be analyzed even if there is any defect in the semiconductor device as a source of comparison.

### Second Embodiment

Referring to the drawings, a second embodiment of the present invention will be described in detail below. FIG. 2 is a block diagram illustrating a configuration of an analysis apparatus for a semiconductor device according to a second embodiment of the present invention. A configurational difference of the present embodiment from the first embodiment is that the present embodiment includes a contrast image generation and display unit 20 in place of the SEM image display unit.

A semiconductor device, for example, a semiconductor wafer formed with a plurality of elements is introduced into the SEM apparatus and an observation position is set to an optional coordinate position of each element. Secondary-electron images (SEM images) of a semiconductor device to be analyzed is input into an analysis apparatus for a semiconductor device from the SEM apparatus, one of which is output to the region determination unit 10 and the other is output to the contrast image generation and display unit 20 as a SEM image to be analyzed. A flow from the region determination unit 10 to generation of a dummy good-product secondary-electron image (SEM image) is the same as for the first embodiment.

The contrast image generation and display unit 20 according to the present embodiment generates a contrast image between a secondary-electron image (SEM image) of a semiconductor device to be analyzed and a dummy good-product secondary-electron image (SEM image) generated from a secondary-electron image (SEM image) of a semiconductor device as a source of comparison and design data thereof. For example, as illustrated at a lower stage of FIG. 2, a contrast image 25(D) can be obtained which expresses, in concentration, a concentration difference between a secondary-electron image (SEM image) 21 of a semiconductor device to be analyzed and a dummy good-product secondary-electron image (SEM image) 24 as a source of comparison.

The present invention can facilitate identification of a defective position 25(D) of the semiconductor device to be analyzed in the same way as for the first embodiment described above. Particularly, in the present invention, it is expectable that edges of a secondary-electron image (SEM image) of a semiconductor device to be analyzed and a dummy good-product secondary-electron image (SEM image) meet each other and concentrations in regions having no malfunction meet each other and therefore in a contrast image, a concentration difference due to unmatch is difficult to generate.

The preferable embodiment of the present invention has been described above, but it is to be understood that the present invention is not limited thereto and that further changes, substitution and modifications may be made in the present invention without departing from the spirit and scope thereof. For example, the respective embodiments have been described assuming that a defective position is found by comparison of an image or generation of a contrast image, but for example, a configuration can be adopted which has a function of automatically detecting a possible defective position by detecting a position (area) in which a concentration difference of more than a fixed value occupies more than a predetermined area per unit area or a function of automatically narrowing down a position of comparative observation or generation position of a contrast image.

In addition, for example, the above-described embodiment has described that a secondary-electron image is obtained from a SEM apparatus, but various types of inspection apparatuses having a charged particle irradiation function such as FIB apparatus and a secondary-electron image generation function can be used.

The foregoing embodiment has described as a configuration independent of a SEM apparatus, but the present invention can be realized as one function of a SEM apparatus or a FIB apparatus.

What is claimed is:

1. An analysis apparatus for a semiconductor device, comprising:
a region determination unit which determines a region constituting a secondary-electron image of a semiconductor device to be analyzed obtained by irradiating charged particle beam, based on the secondary-electron image and design data of the semiconductor device as a source of comparison;
a material identification unit which determines a material of each configuration of an image obtained by the region determination unit, based on the design data of the semiconductor device;
a unit which calculates a potential in the each region identified by the material identification unit, based on the design data of the semiconductor device;
a unit which colors each region of an image obtained by the material identification unit in accordance with the potential and generates a dummy good-product secondary-electron image; and
a unit which displays the dummy good-product secondary-electron image and the secondary-electron image for the semiconductor device to be analyzed.

2. The analysis apparatus for a semiconductor device according to claim 1, wherein the dummy good-product secondary-electron image and the secondary-electron image for the semiconductor device to be analyzed are alternately displayed at the same position of the same screen for comparison thereof.

3. The analysis apparatus for a semiconductor device according to claim 1, further comprising a unit which generates a contrast image between the dummy good-product secondary-electron image and the secondary-electron image for the semiconductor device to be analyzed.

4. The analysis apparatus for a semiconductor device according to claim 1 including a secondary-electron image generating apparatus which generates a secondary-electron image by irradiating an object to be observed with charged particle beam and detecting a secondary electron.

5. An analysis method for a semiconductor device, comprising:
determining a region constituting a secondary-electron image of a semiconductor device to be analyzed obtained by irradiating charged particle beam, based on the secondary-electron image and design data of the semiconductor device as a source of comparison;
determining a material of each configuration of an image obtained by the region determination unit, based on the design data of the semiconductor device;
calculating a potential in the each region identified by the material identification unit, based on the design data of the semiconductor device;
coloring each region of an image obtained by the material identification unit in accordance with the potential and generating a dummy good-product secondary-electron image; and
displaying the dummy good-product secondary-electron image and the secondary-electron image for the semiconductor device to be analyzed.

6. The analysis method for a semiconductor device according to claim 5, wherein the dummy good-product secondary-electron image and the secondary-electron image for the semiconductor device to be analyzed are alternately displayed at the same position of the same screen for comparison thereof.

7. The analysis method for a semiconductor device according to claim 5, further comprising generating a contrast image between the dummy good-product secondary-electron image and the secondary-electron image for the semiconductor device to be analyzed.
